(19) United States
(12) Patent Application Publication
(10) Pub. No.: US 2025/0376067 A1
(43) Pub. Date: Dec. 11, 2025

(54) SYSTEM AND METHOD OF ORGANIZING AND OPERATING ELECTRIC CHARGING SITES

(71) Applicant: George G. SHARP, Simi Valley, CA (US)

(72) Inventor: George G. SHARP, Simi Valley, CA (US)

(21) Appl. No.: 19/222,194

(22) Filed: May 29, 2025

Related U.S. Application Data
(60) Provisional application No. 63/657,938, filed on Jun. 9, 2024.

(51) Int. Cl. B60L 53/67; B60H 1/00; B60L 53/30; B60L 53/36; B60L 53/65; B60L 53/66; G06Q 10/04

(52) U.S. Cl. CPC B60L 53/67; B60H 1/00392; B60L 53/30; B60L 53/36; B60L 53/65; B60L 53/66; G06Q 10/043; B60L 2240/62; B60L 2240/667; B60L 2240/68

(57) ABSTRACT

Presented are a method and system of an algorithmic and computerized approach to organizing and operating electric vehicle (EV) charging sites. The system leverages statistical modeling, real-time data analytics, and automated vehicle management to optimize charging infrastructure utilization, and enhance energy efficiency. The method and system of the present disclosures include three core elements: 1) Synthetic Fleet Identification: In some embodiments, a computerized algorithm detects independently owned/operated EVs that congregate at the same locations and times, forming “synthetic fleets.” 2) Automated Indoor Charging Sites: In some embodiments, this includes deployment of climate-controlled, closed-environment indoor charging facilities that provide optimal work environment for vehicle batteries charging and charging equipment performance. 3) Managed Charging: In some embodiments, this includes elimination of EV drivers' participation in the charging process through automation of vehicle movement, charging stall allocation, and power distribution using AI-driven scheduling and control mechanisms to ensure high site efficiency and utilization.

### FIELD OF INVENTION

The present disclosure pertains to methods and systems for conducting EV charging site placement, organization, and operations.

### BACKGROUND

Electric vehicles (EVs) are now commonplace in developed countries, and yet improvements can be made to enable EVs to have more widespread and/or more efficient use. Public charging stations are growing in number, but it would be desirable to increase their availability, improve on their reliability, safety and comfort, while increasing sites utilization to improve profitability and return on investments. Substantial upfront costs, unpredictable, volatile, and low site utilization, increasing maintenance costs, and poor customer experience continue to cause low profitability in Public Charging. In general, there is a need to improve the public charging experience for EVs.

### BRIEF SUMMARY

The present disclosures include an improved method of organizing and operating indoor charging sites with controlled closed environment providing managed charging that does not require drivers' presence and servicing synthetic fleets, vehicle groups that collectively behave like fleets by dwelling at the same public location at the same time(s).

Accordingly, several advantages are to improve charging site utilization, smoothen demand volatility, provide reliable and predictable charging, and better customer experience. Still, further advantages will become apparent from a study of the following description.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a master EV charging site management center that may control the various components described in these disclosures, according to some embodiments;

FIG. 2 provides a summary description of three distinct components of the present disclosures, according to some embodiments;

FIG. 3 provides a schematic view of the various factors that are used as inputs to the computerized synthetic fleet identification algorithm;

FIG. 4 provides example schematic details of the factors that provide inputs to creating a controlled and automated indoor charging site, as well as an algorithm for how the inputs are processed to generate an optimized indoor environment; and

FIG. 5 provides an example schematic of the various inputs and algorithms utilizing the inputs to perform the automated managed charging.

### DETAILED DESCRIPTION

The present disclosure pertains to methods of conducting EV charging site placement, organization, and operations. With the ongoing adoption of electric vehicles and overall transportation electrification, charging site availability and reliability have become crucial elements of infrastructure supporting electric vehicle motorists.

There are two distinct types of EV charging sites, each with unique operating methods. The first type caters to fleets at private depots, offering the advantage of centralized charging for a group of vehicles under the same ownership and/or control (Fleet Charging). The second type serves the EVs owned by individual members of the general public, at publicly accessible locations (Public Charging). Understanding these differences is crucial for effective infrastructure planning and development and operations planning.

Fleet Charging predominantly employs high-voltage Direct Current Fast Charging (DCFC) Electric Vehicle Supply Equipment (EVSE), the fastest way to charge larger batteries used by business electric vehicles and trucks (BEV). DCFC, or Fast Charging, may take up to 15-45 minutes to recharge the battery of a light-duty passenger vehicle and multiple hours to recharge the battery of a heavy-duty industrial truck. Including all taxes, fees, delivery, and installation costs, DCFC chargers can easily cost more than USD $100,000 per unit, a substantial capital investment for fleets needing tens of DCFC units.

Public charging may use a mix of DCFC and Level 2 (L2) chargers. L2, or Slow Charging, can fully charge the battery of a light-duty passenger vehicle in several hours, typically four to six hours. L2 chargers are inexpensive compared to DCFC, and including all costs can result in up to a USD $10,000 investment per unit.

Operating methods for both types of sites include several major phases-1) Site Selection and Planning, 2) Construction, and 3) Operations and Maintenance (O&M). However, specific steps and their specific implementation vary significantly due to the nature of the sites.

Fleet Charging is managed in-house at private depots, behind the fence. Since the depot location is given, the first phase, site selection and planning, is reduced to the planning step. Because the number of fleet vehicles is known and the existing depot already has an adequate number of parking spaces and related infrastructure and facilities to accommodate and support all the fleet vehicles, the focus of planning is to assess available power capacity and ensure that all fleet vehicles can be charged while site utilization is high enough to justify substantial investments.

The next phase, construction, includes multiple steps: obtaining permits, procuring specialized EVSE and, in some cases, high-voltage power-grid equipment, carrying out construction works, installing equipment, energizing the resulting electric vehicle charging infrastructure (EVCI), commissioning EVCI with the local authorities and power utility company, and setting up monitoring and charge management software and telecommunications to ensure interoperability and proper work of multiple elements of the infrastructure.

Most depots are fenced and have buildings with amenities for depot personnel. Since existing depots already have the infrastructure for parking and serving vehicles, most of the construction work is focused on deploying EVCI.

After EVCI is deployed and commissioned, depot employees are trained to perform EV charging correctly and maintain EVSE properly to ensure uninterrupted business operations.

The O&M phase follows the construction phase. Fleet vehicle charging can be performed by fleet drivers or depot technicians trained to follow safety rules and regulations. After finishing work shifts, drivers park vehicles at a depot, where drivers or technicians charge vehicles by connecting (plugging) them to EVSE. Charging typically happens overnight. If a fleet employs technicians, these professionals can also perform in-house vehicle and EVSE maintenance while vehicles are charging or not used. The following day, when a vehicle's battery is charged to a desired level, the vehicle is disconnected (unplugged) from EVSE, and a driver is ready to start their shift and leave the depot.

Parking availability is not a concern from the drivers' perspective as, by design, depots have enough parking spaces to accommodate all fleet vehicles. Similarly, charger availability and reliability are not an issue for drivers, as electric vehicle depots are designed to support the charging of all fleet vehicles, and EVSE is well maintained by qualified personnel. Moreover, safety and security are not an issue for drivers as a typical depot is fenced and secure. Additionally, fleet drivers can access depot amenities, including restrooms and lunch break rooms.

Most importantly, fleets enjoy predictable charge site utilization. The number of fleet vehicles is known; fleet vehicles are usually parked at the depot for overnight charging, and fleet vehicles commonly have predictable routes and, thus, power consumption needs. As a result, the range of electric power required to recharge BEVs is known, and it is possible to forecast with a high degree of confidence. This utilization predictability allows businesses to plan their profitability to justify the substantial upfront investment.

While fleet charging enjoys predictable charge site utilization, it underutilizes depot charging by design. Because most fleet vehicles leave depots during the day to drive for business purposes, EVCI is used mostly overnight when vehicles are back to recharge. However, this underutilization is beneficial for business. On the one hand, utility companies charge additional fees for power provided during the day and peak power use hours, which can be substantial. On the other hand, the goal of fleet charging is to maximize vehicles' uptime (driving time) while minimizing the cost of ownership, including the cost of power used for charging. Thus, it is beneficial for fleets to charge vehicles overnight underutilize depot EVCI during daytime as fleet depots are cost centers while driving during the day and conducting business is a revenue-generating activity.

In sum, fleet vehicle charging happens at private, fenced, and secure depots with amenities; these depots usually have adequate parking and charging capacity to support all the fleet vehicles; charging is a reliable process performed by trained personnel; and by design, fleet charging has predictable charge site utilization.

The second type of charging site is public charging, intended for the general public at publicly accessible locations. Public charging sites are developed and operated by charge point operators (CPOs), companies specializing in EV charging. Public charging sites use L2 and DCFC charging. L2 chargers are used at locations where motorists park EVs for extended periods, at least hours, including parking spaces and garages, shopping malls, entertainment venues, and other points of interest (POIs). DCFC chargers are typically used at dedicated sites close to major roads for motorists to charge EVs as fast as possible, akin to traditional gas stations where drivers stop by to refill their tanks quickly. Since fast charging can still take more than 30 minutes, fast charging sites are sometimes co-located at POIs, specifically shops and restaurants, to allow motorists to utilize their waiting time productively.

The site selection and planning phase is the critical phase that lays a foundation for further site operations. The first and most important element of operating a public charging site is finding a suitable location that is attractive for motorists to access and use, has adequate power capacity, is properly zoned, and can be used to build a charging site. Since, in contrast to fleets, the number of public vehicles charging on any day is unknown, and site acquisition and development require upfront capital, location selection becomes an important factor in determining the site's future utilization and, thus, profitability. Moreover, since properties for public charging sites are typically leased, monthly rent payments burden public charging sites' profitability, thus making it even more important for public charging sites to reach a profitable utilization level to justify investments.

Because of the uncertainty surrounding potential site utilization, planning commonly focuses on minimizing the upfront investment in hopes of reaching profitability in the future. That is why most sites are simple open spaces with no amenities, protection from the elements, or even adequate lighting for the dark time of the day, making charging unsafe.

Moreover, many CPOs rely on federal and state government subsidies and incentives to develop EV charging sites. Notably, the National Electric Vehicle Infrastructure (NEVI) program funded by the US DOT allocated $5 billion to strategically deploy EV charging stations. Most governmental support is focused on disadvantaged communities (DACs) and major interstate transportation corridors. However, these regions typically don't have many EV motorists and may lack convenient and/or safe sites to dwell for an extended time while charging EVs. Additionally, CPOs pursuing subsidies and incentives for charging sites should make their sites accessible to any general public member as a condition of receiving such subsidies and incentives. Thus, client segmentation to serve only specific segments makes CPOs ineligible for subsidies. Therefore, CPOs pursuing governmental subsidies and incentives build charging sites at locations that lack adequate traffic, resulting in very low utilization, typically in the single-digit percent.

The construction phase for public charging also has more steps than fleet charging. Since DCFC is high-voltage equipment accessible to the general public, public fast charging sites require more permits from local governments, regulators, and utilities. It is also typical for public charging construction to spend more time and resources on environmental studies and assessments and navigate construction around multiple property easements and utility setbacks. Those sites that receive governmental funding may need to comply with the Americans with Disabilities Act (ADA), requiring additional space and facilities available. Sites that need to build restrooms require additional permitting and work on the plumbing and sewage systems. For some sites, local regulations may require site developers to follow the prevailing wage requirements.

On the equipment side, EVSE used in public charging must satisfy public safety and usability requirements. For example, EVSE may need an additional cable management system to make lifting and operating a heavy charging port and cable easier for an average person. The functionality for accepting payments requires a telecommunication module for connectivity. Such additional hardware elements increase equipment costs.

All these additional steps and elements increase overall construction costs, making public charging site development even more reliant on subsidies and incentives, and thus facilitating CPOs' focus on sites eligible for subsidies and incentives and serving the general public without being able to segment client base.

After the construction of a public charging site is completed and the site is opened to the general public, the operations and maintenance (O&M) phase starts. On the operations side, all currently available public charging sites are self-serve sites with charging performed by EV drivers themselves. Even in New Jersey, where state law requires gas stations to provide full-service and employ attendants, all EV public charging sites are self-service. With EV adoption becoming mainstream and progressing from innovators and technically-savvy early adopters to the early majority of the general public, more user mistakes, improper equipment use, or even accidental damage happen regularly. In many instances, vandalism and equipment destruction, notably cable theft, result in total inoperability of the entire public charging site.

EVSE compatibility with multiple EV models by multiple manufacturers creates another level of complexity and issues from an operational perspective and negatively affects drivers' experience. For charging to start, a battery-built-in mini-controller should successfully connect with the EVSE (“handshake”) to exchange information about charging parameters. However, because of the wide variety of equipment used, sometimes this handshake doesn't work properly, resulting in the incompatibility of a specific EVSE model with a specific EV, especially older models. Average users may be unaware of such technical nuances and thus unsuccessfully attempt to connect their vehicles to charging stations while not charging, occupying charging stalls, and preventing or deterring other motorists from using charging stations, resulting in a negative customer experience and public charging site underutilization.

EV batteries have limitations on how much power they can accept (“vehicle charge acceptance rate”). When a motorist attempts to charge their EV with a low vehicle charge acceptance rate using DCFC with a much higher power capacity, the charging is conducted at the lowest power capacity of the vehicle charge acceptance rate. This results in longer than expected charging time, bad customer experience, and a lower site utilization below the plate capacity.

Customer payment processing is another operational function that requires considerable attention. Without proper user authentication, EVSE stops operating to prevent CPOs from financial losses by providing free power. The public charging site becomes inoperable when EVSE connectivity to the internet and a payment processing provider is limited or interrupted.

To alleviate these and many other issues, CPOs provide customer support by phone or online to support and educate drivers. However, maintaining a call center and/or adequate support team results in significant business overhead and affects profitability without significantly improving customer experience, as remote support employees may be unable to resolve some customer issues without physical presence at the site.

There are many cases when criminals attach to EVSE stickers with what looks like legitimate customer support information but have phone numbers or QR codes redirecting customers to false call centers and/or websites gathering personal and banking information for criminal purposes.

In most cases, drivers lack adequate support, and the most common solution for drivers when experiencing issues is to try another EVSE at the same site, if available, or go to another public charging site in hopes of being able to charge their EV there.

For well-maintained sites, high utilization becomes a deterrent for drivers. The more the site becomes reliable and popular, the more drivers come to charge their vehicles, and the site becomes overcrowded. This results in some drivers waiting for other motorists to complete charging and vacating stalls. The industry estimate is that 30% utilization is the highest sustainable utilization rate. At the greatest rates, driver dissatisfaction forces drivers to find alternative sites, which self-corrects the utilization and brings it down to the sustainable level.

While daytime depot charging underutilization is a beneficial feature of fleet charging, resulting in lower charging costs, public charging site underutilization results in lost revenues. Even during the daytime, when power utilities charge fees for peak power use, some EV motorists are still willing to pay a premium to change their vehicles. So, public charging site underutilization is detrimental to CPO revenues.

On the maintenance side, CPOs must maintain and repair their equipment. Technicians need to visit sites to assess issues and attempt to repair EVSE. If parts are required, they most likely need to be ordered. Depending on the EVSE manufacturer and warranty terms, parts can be available in a few days, weeks, or months. Then, a follow-up visit should be arranged to attempt to repair equipment and resolve issues while all this time in between visits EVSE is out of service.

A maintenance crew may be able to visit only a few sites per day. In high-density populated urban areas, because of heavy traffic, traveling from site to site can take hours despite relatively close distances. In urban areas and highway corridors, charging sites can be scattered over large areas with significant distances from each other, again taking time for technicians to travel. Moreover, a country-wide shortage of technicians, specifically electricians, adversely affects many industries, including EV charging. As a result of this shortage, maintenance costs are increasing while equipment uptime is not improving or even declining.

From the EV drivers' perspective, operational and maintenance deficiencies result in poor experience at fast charging public sites, with limited availability, unpredictable reliability, safety concerns, lack of basic comfort, and inadequate customer support.

Recent attempts have been made to improve the quality of public charging and drivers' experience. Some CPOs build charging self-service sites with EVSE located outdoors under open-air covers and an indoor rest area with restrooms, coffee shops, food courts, and places for drivers to sit comfortably indoors while their vehicles charge. However, this approach requires increased upfront investment into additional infrastructure that needs to be justified by increased utilization and auxiliary revenues from food and drink sales.

Despite the public charging industry being more than 15 years old, with two major publicly traded companies, ChargePoint and EVGo, starting to operate in 2007 and 2010, respectively, there is still a long-felt but unsolved need to improve charging services availability, reliability, safety, and comfort, while increasing sites utilization to improve profitability and return on investments. Substantial upfront costs, unpredictable, volatile, and low site utilization, increasing maintenance costs, and poor customer experience continue to cause low profitability in public charging. The governmental subsidies and incentives provide support to CPOs but limit subsidy recipients' flexibility in selecting sites and the ability to serve specific segments of the general public.

Aspects of the present disclosure address these issues and others through description of a method and system of an algorithmic and computerized approach to organizing and operating electric vehicle (EV) charging sites. The system leverages statistical modeling, real-time data analytics, and automated vehicle management to optimize charging infrastructure utilization, enhance energy efficiency, and provide other benefits.

The method and system of the present disclosures include three core elements: 1) Synthetic Fleet Identification: In some embodiments, a computerized algorithm detects independently owned/operated EVs that congregate at the same locations and times, forming “synthetic fleets.” 2) Automated Indoor Charging Sites: In some embodiments, the system and method includes deployment of computer system climate-controlled, closed-environment indoor charging facilities that provide optimal work environment for vehicle batteries charging and charging equipment performance. 3) Managed Charging: In some embodiments, the method and system include elimination of EV drivers' participation in the charging process through automation of vehicle movement, charging stall allocation, and power distribution using AI-driven scheduling and control mechanisms to ensure high site efficiency and utilization.

The indoor EV charging sites providing managed charging to synthetic fleets, as described herein, ensure higher site utilization predictability and optimized resource management compared to conventional public charging solutions.

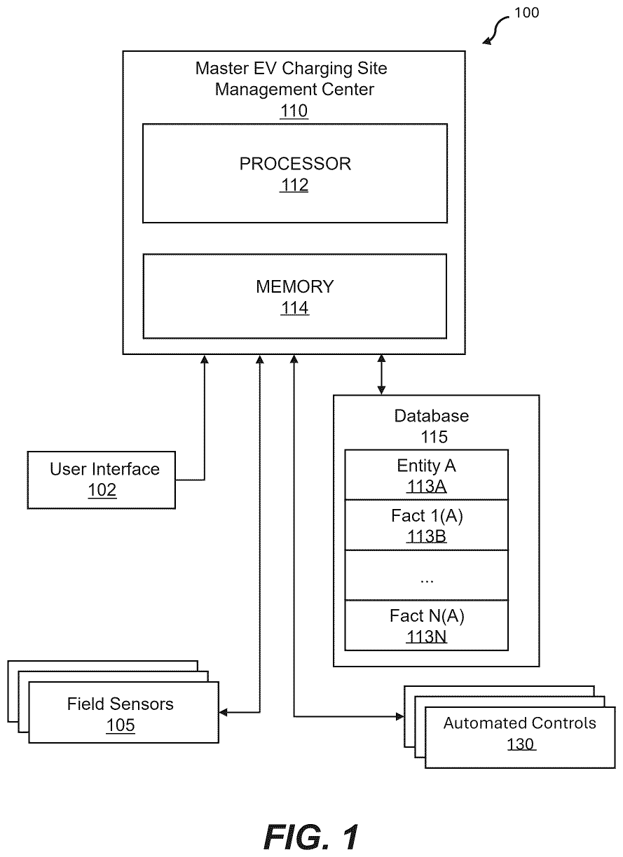

Referring to FIG. 1, diagram 100 provides a schematic for a master EV charging site management center 110 that may be used to perform the various functionalities described in the present disclosures, according to some embodiments. The EV management center 110 may provide analysis and computation necessary to find suitable locations for synthetic fleet sites, control the automation of the indoor charging sites once they are constructed, and/or manage the charging of the indoor charging sites to efficiently operate them. The EV charging management center 110 may include one or more processors 112 and one or more memories 114. A user interface 102 may be provided to allow commands to be received and to allow the EV charging management center 110 to be programmed or receive additional inputs. A database 115 may be communicably coupled to the management center that contains various facts about various potential charging sites, as exemplified by various entities such as Entity A 113A. The potential charging sites may have associated with them facts 1(A) 113B through N(A) 113N that are useful for determining whether they are optimal charging sites. Examples of these factors will be described in more detail below. In other cases, the database 115 may include descriptions of EV vehicle models and their specifications in order for the management center 110 to determine how to optimally manage their charging among the set of charging stations.

Various field sensors 105 at a facility may be communicably coupled to the charging site management center 110. The field sensors 105 may be installed in an indoor charging facility contemplated by the present disclosures. These may provide necessary feedback for detecting what EVs are being charged, what the environmental conditions in the indoor facility are like, and the state of saturation and traffic in the indoor facility. Based on these inputs, the management center 110 may provide instructions to various automated mechanisms in the indoor facility through automated controls 130. These may represent various commands that access automated machines in the indoor facility to manage the operation of an indoor facility. Examples of these will be described in more detail below.

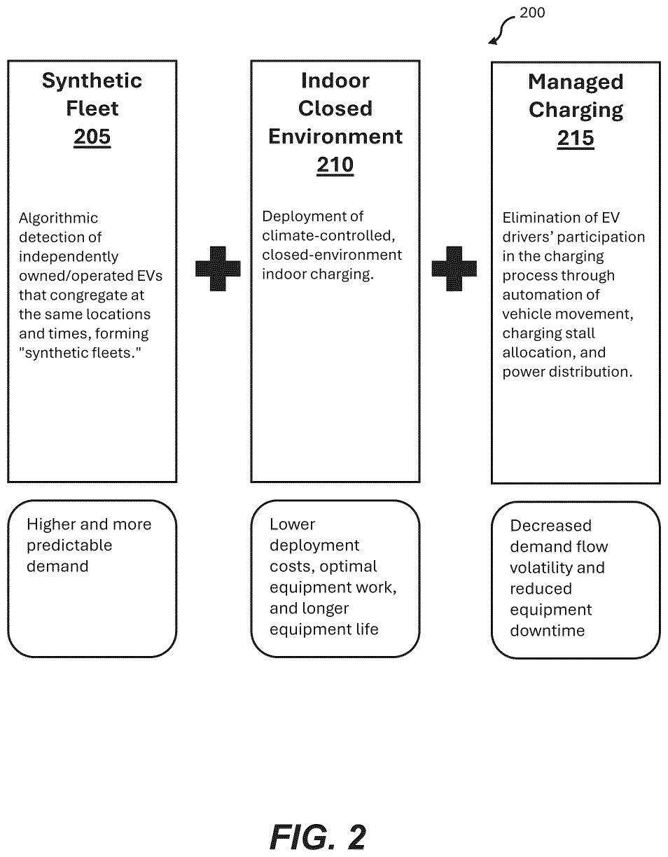

Referring to FIG. 2, diagram 200 provides a summary description of three distinct components of the present disclosures, according to some embodiments. The first component is the synthetic fleet identification algorithm 205 that may be implemented in the charging site management center 110, for example. The computer algorithm may perform detection of independently owned and/or operated EVs that congregate at the same location and in some cases, the same times. These collections of EVs form synthetic fleets that may provide an efficient location for charging sites to be constructed, at scale. The description of the algorithm will be elaborated in more detail below.

In addition, a second component is the indoor closed environment charging site 210. Indoor charging sites that are climate controlled and account for other environmental factors provide lower deployment costs, optimal equipment work, and longer equipment life. Example embodiments of the indoor closed environment charging sites will be described more below.

Lastly, a third component is the managed charging 215 of EVs when they are placed in the charging stations of the indoor charging environment. This may be controlled by the management center 110, for example. In some embodiments, these the managed charging at the indoor sites provide automated charging facilitation so that drivers do not need to be involved in the EV charging. Efficient management of the indoor facility may reduce volatility and equipment downtime. Examples of how the indoor sites may be managed to charge EVs in an automated fashion are described more below.

### Synthetic Fleet Identification Algorithm

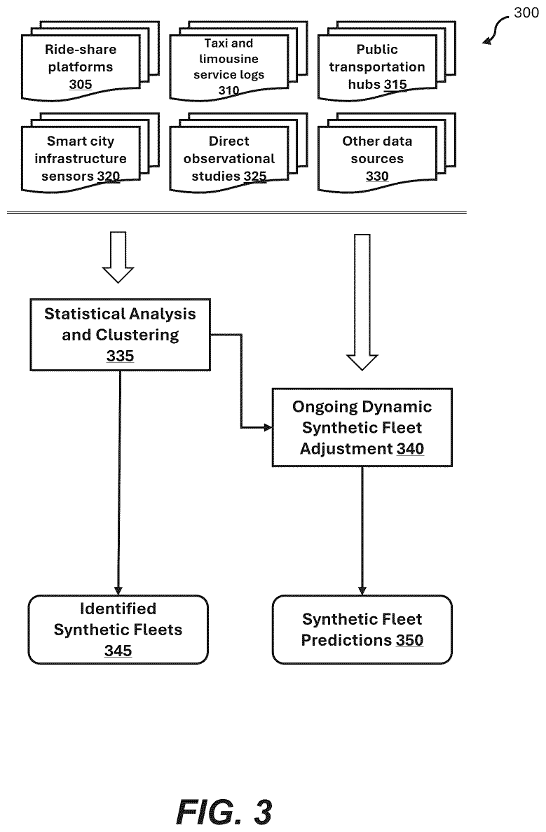

In some embodiments, and in reference to FIG. 3, the synthetic fleet identification algorithm implemented in a computerized system includes several components: data collection; statistical analysis and clustering, and dynamic synthetic fleet adjustment. Diagram 300 provides a schematic view of the various factors that are used as inputs to the computerized synthetic fleet identification algorithm. The algorithm may be implemented by a server, such as the management center 110.

In some embodiments, to perform the data collection component, the system collects longitudinal geo-data from various sources, including: ride-share platforms 305, taxi and limousine service logs 310, public transportation hubs 315, smart city infrastructure sensors 320, and direct observational studies 325. As some examples of ride-share platforms data 305, the system may receive time-stamped geo-data from a ride-share company for passenger pick-ups, drop-offs, ride-share vehicle dwell locations, durations, etc. As some examples of taxi and limousine service logs data 310, the system may receive service calls data from taxi and limousine companies with information about pick-up times, drivers' availability times after finishing rides, pick-up and drop-off locations, etc. As some examples of public transportation hubs data 315, the system may receive traffic statistics from a local transportation authority with details about passenger traffic and concentrations. More specifically, the system may receive time-stamped entry/exit counts from airport terminals or parking structures, correlated with EV registration plate scans and identification of ride-share vehicles. As some examples of smart city infrastructure sensors data 320, the system may obtain a city's smart infrastructure capturing license plates of vehicles that dwell in a parking garage for more than 30 minutes-cross-referenced against EV registries and Uber/Lyft affiliation. As some examples of direct observational studies data 325, the system may obtain anonymized cellular tower or Wi-Fi analytics data showing repeat presence of vehicles or devices in a particular location, clustered around certain hours (e.g., morning drop-offs at a corporate campus). Other sources of data 330 may be provided that are apparent to those with skill in the art, and embodiments are not so limited. For example, the system may acquire data empirically by observing passenger flow, arrivals and departures at different locations, and passengers' use of ride-share vehicles.

In some embodiments, to perform the algorithm, statistical analysis and clustering 335 may be employed. The system may ingest the data obtained in the data collection phase and perform a spatiotemporal clustering algorithm (e.g., k-means, DBSCAN) to detect high-density EV congregation at public locations. The data disclosing locations of ride sharing drop offs and pick ups can provide location densities for where ride sharing EVs travel typically. Similarly, tax and limousine service logs, public transportation hubs, and direct observational studies can provide additional layers of this kind of data to create heat maps of EV travel locations. Smart city infrastructure sensors may also be used in this way. This may produce an identification of optimal synthetic fleet locations 345. The locations may be expressed in a confidence interval or score. As some additional examples for performing the site identification algorithm, the system may apply clustering algorithms, DBSCAN or K-Means, to GPS coordinates in combination with timestamp data to identify recurring EV dwell zones. As another example, the system may apply time series peak analysis to detect daily/weekly recurring peaks in vehicle presence at the same location (e.g., 7-9 AM weekday peaks at a suburban park-and-ride lot). As another example, the system may use GIS (Geographic Information System) tools to visualize hot zones of high-density (heatmaps of dwell density), time-aligned EV presence, which may signal synthetic fleet behavior. In other embodiments, the system may aggregate two or more of these example algorithms to generate an aggregate location that is weighted by its proximity to each of the results. For example, if two or more algorithms independently reach the same location or nearly the same location, this may provide a heavily weighted location of an optimal location site.

Furthermore, time-series analysis can be used to identify patterns of EV pickup/drop-off behavior to predict peak periods. The data may include time stamps to provide multi-dimensional plots of locations at particular times. Then, using machine learning modeling, a predictive model may estimate future synthetic fleet behavior using historical movement data combined with real-time traffic and weather inputs.

In some embodiments, after a model is created, the system may perform dynamic synthetic fleet adjustment 340 to continuously update the model based on new real-time data. To do this, for example, machine learning (ML) regression models predict fluctuations in EV concentration based on seasonal trends and local event schedules. Furthermore, synthetic fleet predictions 350 may be directly integrated into indoor charging site power and space planning, ensuring optimal resource allocation. For example, a charging hub sees heavy ride-share EV traffic from 7-9 AM and 4-6 PM. Midday, traffic shifts toward delivery vans doing lunch-hour drop-offs. The system may dynamically adjust synthetic fleet recognition and prioritizes ride-share vehicles in morning/evening windows and adapts parking/charging assignments in real-time. As another example, an indoor charging site near a stadium expects an influx of EVs on a game day. Based on real-time traffic flow and license plate recognition, a temporary synthetic fleet is recognized (event-goers arriving in EVs), charging schedules are reprioritized to handle short-duration dwellers (e.g., those dropping people off), overflow parking is preallocated, and HVAC/climate optimization is triggered for expected peaks. As yet another example, indoor site sensors detect a growing queue of EVs in the staging area. Meanwhile, GPS feeds show unexpected rerouting of ride-share EVs due to road closures. The synthetic fleet model may be updated in real-time. Charging queues are reprioritized. A temporary dynamic override shifts resources to minimize wait times and maintain high utilization. These reconfigurations may all be performed or facilitated by the system in FIG. 1, for example.

### Automated Indoor Charging Sites

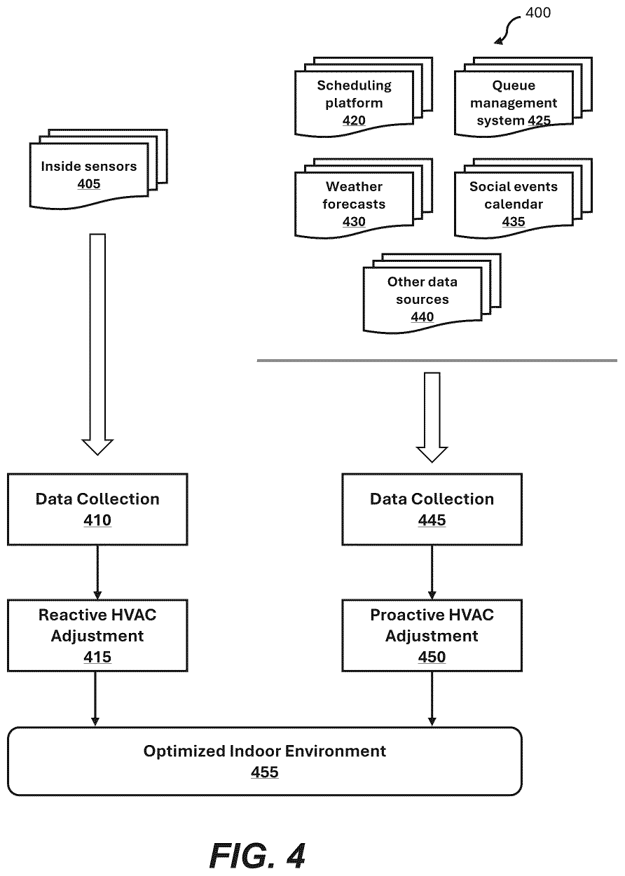

In some embodiments, with reference to FIG. 4, the system includes indoor charging sites that are enclosed, providing a controlled and protected-from-elements work environment that enhances charging efficiency and ensures optimal operational conditions for EV batteries and charging equipment. Diagram 400 provides example schematic details of the factors that provide inputs to creating a controlled and automated indoor charging site, as well as an algorithm for how the inputs are processed to generate an optimized indoor environment. In some embodiments, the automated indoor charging sites of the present disclosures include several components: a site placement algorithm, data collection, and closed-environment facility optimization.

In some embodiments, one aspect includes methods for efficiently selecting the site for the automated indoor charging facility. Based on the outputs of the synthetic fleet identification algorithm, as described above, the system may identify locations at or close to synthetic fleets to ensure that charging sites are in direct proximity to EV charging demand. For example, a location close to an airport with passengers using ride-share services. As another example, one optimal location may be a central train station in a big city with passengers coming from the suburban area to the city and using ride-share or taxi services to reach their final destinations. As another example, an optimal location may be a coastal city seaport with cruise ships stopping regularly and passengers getting off the ships to explore the city and use ride-share or taxi services. As yet another example, a prime location may be a rest area on a high-traffic highway with EV drivers stopping to refresh, eat, and/or rest. Using the inputs as described above in the example descriptions of the site location algorithm, the system may converge on a location like what is described here.

Next, the system may perform additional data collection to collect environmental data from various sources, including: Inside sensors 405 and outside detectors, weather forecasts 430, an internal EV charging scheduling platform 420, an internal charging queue management system 425, and a social events calendar 435. As an example of inside sensors 405, the system collects environmental data from sensors installed at the site, inside and outside the facility. The sensors measure temperature and humidity to adjust HVAC system settings automatically. As an example of using an internal charging queue management system 425 to make adjustments, the system uses charging que management data and charging schedules to forecast future short-term demand. Based on the expected power load, the system calculates optimal indoor environmental parameters for the coming power load. The system adjusts HVAC settings preventively to ensure stable optimal working environment for EVSE and vehicle batteries. As an example of use of a social events calendar data 435, the system may use data available about nearby social events (e.g., sport games, concerts, conferences, etc.) that may result in increased charging demand at the site and calculates and automatically adjusts indoor environmental parameters to ensure stable optimal working environment. As an example using weather forecasts 430 to make adjustments, the system may use external weather forecast data to adjust the HVAC system. Other data sources 440 may be utilized that may be apparent to those with skill in the art, and embodiments are not so limited.

When a site is operational, the closed-environment system may include various components to optimize its operation. For example, the facility may include an automated system that compares inside sensors 405 measurements with the environmental parameters range for equipment optimal work and adjusts HVAC controls accordingly to bring environmental parameters into the target range. The data collection process 410 may aggregate data from the inside sensors 405. This may produce a reactive HVAC adjustment 415 that is based on the data received live and inside the facility. As an example of the inside sensors 405 providing a feedback adjustment, the sensors may detect increasing humidity as multiple vehicles arrive during a summer rainstorm. The HVAC systems may automatically adjust to prevent condensation, which can affect charging connectors.

On the other hand, the data collection process 445 may aggregate the data from the various factors described above. As another example, the facility may include an environment control predictive model that uses weather forecast, data from the internal EV charging scheduling platform, and data from internal charging que management system to forecast environmental changes caused by weather and planned demand changes to adjust HVAC controls preventively or proactively (450). As another example, the facility may utilize an event-driven demand predictive model for EV charging demand that uses data from an events calendar and provides feedback to the environment control predictive model to account for potential spikes in higher vehicle flow and proactively prepare the facility's environment. These two methods may be combined or integrated together in continuous feedback to produce an optimized indoor environment 455.

As an example of how the system accounts for demand fluctuations, the system may read upcoming appointments from the digital reservation system. It then forecasts peak vehicle arrivals between 4-6 PM and pre-adjusts HVAC output to stabilize temperature in advance. As an example of the system accounting for a social event calendar 435, the system may incorporate schedules of big sports games, music events, and festivals at the nearest stadiums and concert venues to proactively prepare for a spike in ride-share vehicles coming and pre-adjust HVAC parameters for optimal work environment conditions.

Based on the facility configuration, expected demand fluctuations, and weather forecast, the analytical system automatically estimates the time lag between the HVAC controls adjustment and consecutive environmental parameters changes to account for the time lag between HVAC controls adjustments and internal environmental parameters change.

### Managed Charging

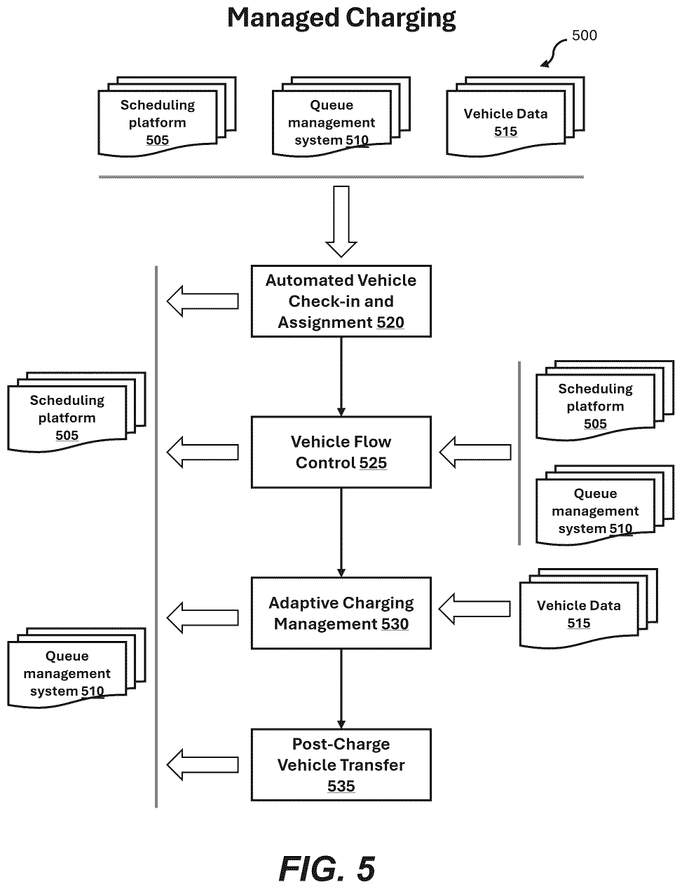

In some embodiments, and in reference to FIG. 5, the charging facility may offer managed charging that is automated for EVs. These services may be put in place within the automated indoor charging sites described above. Diagram 500 provides an example schematic of the various inputs and algorithms utilizing the inputs to perform the automated managed charging. In some embodiments, the managed charging may include several automated components, including: automated vehicle check-in and assignment 520, vehicle flow control 525, adaptive charging management 530, and post-charge vehicle transfer 535. These may be controlled and operated by the management center 110, for example.

Regarding automated vehicle check-in and assignment 520, in some embodiments, the Algorithmic/AI-driven scheduling system may register vehicles upon arrival. Drivers of manned vehicles may drop off their EVs at the entrance and do not interact with the charging process. The facility may assign vehicles to an optimal charging stall, work-in-progress (WIP) queue, or parking. Prioritization may be based on: EV energy need, time constraints, and available power supply. To implement the automated vehicle check-in and assignment system 520, the management center 110 may rely on a scheduling platform 505, a queue management system 510 and vehicle data 515 from the various vehicles that enter the facility.

The automated check-in and assignment process 520 may utilize data from the scheduling platform 505 and queue management system 510, which in turn may cause updates to these same systems. For example, the automated vehicle check-in and assignment program 520 may utilize the scheduling platform 505 to figure out how urgently a vehicle is needed, or what the timing is for each vehicle for its use. In general, the scheduling platform 505 provides the schedule for when things are charged, and therefore may be updated after a vehicle is checked-in and assigned a charging station under the process 520 depending where the vehicle is placed. Similarly, the queue management system 510 reflects the real queue that's actually happening-ideally but not always according to the scheduling platform 505, providing the real time information on how things are actually going in the queues. Relatedly, vehicle data 515 can include the timings of when the vehicle is going to be used, whether it will be long distance, and other stats about the vehicle. In general, the vehicle data may provide a mix of technical detail and scheduling plans for each of the vehicles.

As an example of this feedback/iterative process shown in FIG. 5, an autonomous electric vehicle (AEV) arrives at the site entrance, where the site system recognizes it, for example, by its plate number. The system checks the vehicle in and assigns it to the work-in-progress (WIP) queue or parking. The queue management system 510 may update its status with the AEV by its plate number, showing where it is in the site and what it is doing. The scheduling platform 505 may be updated as well to provide information on when the AEV is going to be charged and when it is projected to be finished charging.

As another example, an AEV arrives at the site entrance and initiates a wireless connection to the system to start communication. The site system establishes a connection and receives vehicle ID and other vehicle and battery-related status information. The system checks the vehicle in and, based on the information received, assigns it to an optimal charging stall, work-in-progress (WIP) queue, or parking space.

As another example, a man-driven electric vehicle arrives at the site entrance, where a site attendant gathers vehicle and battery-related information and enters it into the system. The system checks the vehicle in and, based on the information received, assigns it to an optimal charging stall, WIP queue, or parking space.

As another example, the system uses the battery state of charge (SOC) information, the time the vehicle has to spend at the site before it should leave, and other vehicle, battery, and route-related information to prioritize vehicle charging in accordance with power supply availability and other vehicles' priorities.

As another example: The system uses various data points about a vehicle, its battery, time available before the next route, the next route information, and charging sites available near the destination, to prioritize a charging schedule for the vehicle using AI and other optimization techniques.

Regarding vehicle flow control 525, the system may automatically continuously monitor vehicle flow and dynamically directs vehicles based on charging priority, optimizing spatial and temporal resources. The facility may include sensors at each station and queue to visually identify vehicles and vacant spaces. In addition, the facility may use predictive path-planning algorithms to guide vehicles dynamically. Furthermore, the vehicle transfer operations may be executed using self-driving capabilities in autonomous EVs, and/or AI-coordinated valet personnel (where applicable). For self-driving vehicles, the facility provides navigation and operational instructions to the vehicle AI, directing it to move, charge, park, and leave the facility as required.

As an example of how the vehicle flow control process may operate, the site may employ a combination of permanent signs, dynamic signs/screens, lights, etc., to provide visual guidance for autonomous vehicles that don't have direct connectivity to the system and rely on video/image recognition to navigate. For example, dynamic signs/screens can indicate the destination (e.g., “charging stall 23), while running lights in the middle or along the path can indicate the direction to the destination by color, blinking, or/and running lights.

As another example, the system may provide a detailed site plan, along with site signs and lights, to an autonomous vehicle directly connected to the system to help the autonomous vehicle navigate to the next step in the charging process.

As another example, a site attendant may drive a vehicle to the next steps following instructions from the system. As another example, the system may continuously monitor vehicle flow at various stages and locations and physical and power capacity available, optimizes the use of physical space and charging capacity to maximize effective charging time for vehicles, updates the charging schedule as needed, and guides vehicles to the next steps in the process.

Regarding adaptive charging management 530, in some embodiments, the facility may provide EV charging in an adaptive manner that adjusts to the conditions in the facility, including how many vehicles are present and what the environmental conditions are. For example, upon vehicle placement in a charging stall, the system initiates a connection protocol with EVSE. As another example, charging may be conducted that adheres to predefined parameters that align with the vehicle's specifications and site's energy management protocols. As another example, charging sessions may be optimized using a real-time dynamic load balancing algorithm. In some cases, the facility may monitor battery State of Charge (SOC) levels, and may adapt power delivery accordingly, and provide feedback to the queueing and scheduling systems to use for flow optimization. In some embodiments, an automated stall-release mechanism transfers fully charged vehicles to holding areas to clear stalls faster.

As an example of how the adaptive charging management 530 may operate, an autonomous vehicle supporting wireless charging arrives at a charging stall and positions itself for wireless charging. The charging process may start after the vehicle is correctly aligned with the wireless charging system. As another example, a vehicle driven by a site attendant arrives at a charging stall. The attendant positions the vehicle for wireless charging. The charging process starts after the vehicle is correctly aligned with the wireless charging system. As another example, an autonomous vehicle arrives at a charging stall and positions itself for a power plug/connector to be inserted into its charging port. The power connector can be inserted by automated means (e.g., robo-arm) or manually by a site attendant. As another example, a vehicle driven by a site attendant arrives at a charging stall. The attendant positions the vehicle for charging and manually inserts a power connector into the vehicle's charging port. As another example, the system charges an electric vehicle battery to the target level calculated using information about the battery's current state, environmental conditions, overall site's power availability, and, if known, the vehicle's next route. In some cases, if site utilization is below full, the system may charge the battery to the highest possible level. In other cases, the system may charge the battery to the minimum level, allowing the vehicle to leave the site and get to the next destination to recharge its battery near the destination.

Regarding post-charge vehicle transfers 535, in some embodiments, the facility may also provide automated transfer of vehicles out of the charging stations when the charging is complete. For example, following disconnection from EVSE, the system may initiate the post-charge transfer protocol, relocating vehicles to designated waiting areas based on operational efficiency algorithms. This process optimizes charging stall turnover, freeing up the charging station for the next vehicle in the queue and enhancing site throughput.

As an example of the process occurring during a post-charge vehicle transfer 535, after an autonomous vehicle completes wireless charging, the system directs the vehicle to the site exit. The vehicle may be autonomously operated and may be linked with the system to direct the vehicle through the proper paths. As another example, after an autonomous vehicle completes wired charging, the power connector is unplugged from the vehicle's power plug either automatically (e.g., robo-arm) or manually by a site attendant, and the system directs the vehicle to the site exit. As another example, after a man-driven vehicle completes charging, a site attendant unplugs the vehicle from EVSE and follows the system instructions to drive it either to the site exit to be picked up by the vehicle driver or to the overflow parking to await further instructions while waiting for the vehicle driver to get ready to leave the site.

Based on the disclosures, EV charging sites may be made more optimal and provide a number of improvements over conventional charging sites. Contrary to the common Public Charging industry practice of offering simple outdoor self-service charging sites with no amenities and the common thinking of minimizing upfront investment by pursuing governmental subsidies and incentives that, in fact, limit options for site locations and customer segments, resulting in low charging site utilization, the described methods and systems allow for achieving higher charging site utilization rates and provide other benefits and advantages.

This higher utilization is achieved by targeting synthetic fleets that naturally dwell at the same location simultaneously, thus producing a more predictable and higher demand for charging.

Moreover, indoor charging in a temperature and humidity-controlled environment allows charging site equipment and vehicle batteries to operate in optimal ranges at peak performance, resulting in faster charging, less downtime, and longer equipment service life.

Moreover, deployment of indoor charging facilities can be faster and cheaper in comparison with traditional open space charging sites as indoor EVSE installation does not need costly trenching and underground conduit installations. Also, structural design flexibility allows integration into existing buildings or underground parking facilities, reducing permitting complexity and accelerating site approval process.

Moreover, the site system efficiently utilizes charging equipment and physical space by moving vehicles between the charging stalls, waiting queue, and parking. This ensures that charged vehicles leave charging stalls quickly, resulting in shorter waiting times and contributing to higher charging site utilization.

Moreover, managed charging reduces the number of technical issues, as charging is performed by the site system. This results in less equipment downtime and contributes to higher charging site utilization.

There are many other benefits. Drivers can expect reliable and predictable charging. Additionally, scheduling becomes an option for drivers visiting managed charging sites.

Managed charging sites can also provide motorists additional services, such as vehicle condition check-ups, maintenance, cleaning, and washing. This allows drivers to efficiently utilize their resting time while their vehicles are being charged and maintained.

All these and other benefits for drivers also contribute to higher site utilization.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
an indoor closed environment electric vehicle (EV) charging site comprising a plurality of EV charging stations and a plurality of sensors;
one or more processors communicatively coupled to the plurality of sensors;
a memory coupled to the one or more processors; and
an output module communicatively coupled to the processor to provide a plurality of automated controls for sending commands to the plurality of EV charging stations;
the one or more processors configured to:
identify one or more geographic locations suitable for building a future indoor EV charging site capable of charging a fleet of EVs; and
manage automated charging of a plurality of EVs in the indoor closed environment EV charging site by transmitting commands using the output module to perform automated actions at the indoor closed environment EV charging site.

2. The system of claim 1, wherein to identify the one or more geographic locations suitable for building a future indoor EV charging site, the one or more processors is further configured to analyze geo-data patterns and vehicle congregation behaviors.

3. The system of claim 1, wherein to identify the one or more geographic locations suitable for building a future indoor EV charging site, the one or more processors is further configured to identify locations of synthetic fleets of EVs, wherein the synthetic fleets comprise a plurality of EVs that park in a common location when not in use and are used for a common purpose.

4. The system of claim 3, wherein to identify locations of synthetic fleets of EVs, the one or more processors is further configured to:
apply spatiotemporal clustering and predictive analytics to longitudinal vehicle movement data;
dynamically update synthetic fleet parameters based on real-time traffic, weather, and location-based demand inputs; and
leverage synthetic fleet data to optimize indoor charging facility placement and managed charging queue efficiency.

5. The system of claim 1, wherein to identify the one or more geographic locations suitable for building a future indoor EV charging site, the one or more processors is further configured to collect data comprising ride-share information, taxi and limousine service logs, information from public transportation hubs, and information from smart city infrastructure sensors.

6. The system of claim 1, wherein to identify the one or more geographic locations suitable for building a future indoor EV charging site, the one or more processors is further configure to perform a dynamic synthetic fleet adjustment to continuously update the suitable geographic location based on new real-time data.

7. The system of claim 1, wherein the indoor closed environment electric vehicle (EV) charging site comprises a controlled and protected-from-elements work environment that enhances charging efficiency and ensures optimal operational conditions for EV batteries and charging equipment.

8. The system of claim 7, wherein to manage the controlled and protected-from-elements work environment, the one or more processors is further configured to collect data from the following sources: inside sensors, outside detectors, weather forecasts, an internal EV charging scheduling platform, an internal charging queue management system, and a social events calendar.

9. The system of claim 8, wherein to manage the controlled and protected-from-elements work environment, the one or more processors is further configured to transmit an instruction to adjust an HVAC in the indoor closed environment EV charging site based on the collected data.

10. The system of claim 1, wherein to manage the automated charging of the plurality of EVs in the indoor closed environment EV charging site, the one or more processors further comprises:
a vehicle routing system that directs EVs to optimal charging stalls using LiDAR, V2X, or on-site automation;
a prioritization framework that assigns charging stalls based on charge urgency, vehicle type, and estimated departure times; and
an automated system that moves vehicles or directs vehicle movements between waiting, charging, and post-charging areas to maximize stall availability.

11. The system of claim 1, wherein to manage the automated charging of the plurality of EVs in the indoor closed environment EV charging site, the one or more processors is further configured to:
transmit commands to perform automated vehicle check-in and assignment;
transmit commands to conduct vehicle flow control;
conduct adaptive charging management; and
transmit commands to conduct post-charge vehicle transfer.

12. The system of claim 11, wherein to perform the automated vehicle check-in and assignment of an EV, the one or more processors is further configured to:
initiate a wireless connection with the EV to start communication;
establish a connection with the EV using the wireless connection; and
receive a vehicle ID of the EV;
receive battery-related status information of the EV; and
based on the vehicle ID and the battery-related status information received, assign the EV to an optimal charging stall.

13. The system of claim 11, wherein to perform the automated vehicle check-in and assignment of an EV, the one or more processors is further configured to:
receive information about the EV's battery, time available before its next route, next route information, and charging sites available near a destination of its next route; and
prioritize a charging schedule for the EV based on the received information.

14. A method comprising:
identifying, using one or more processors, one or more geographic locations suitable for building a future indoor EV charging site capable of charging a fleet of EVs; and
analyzing geo-data patterns and vehicle congregation behaviors.

15. An indoor closed environment electric vehicle (EV) charging site comprising:
a plurality of EV charging stations;
a plurality of sensors; and
a controlled and protected-from-elements work indoor space that enhances charging efficiency and ensures optimal operational conditions for EV batteries and charging equipment.

16. A method comprising:
managing automated charging of a plurality of EVs in the indoor closed environment EV charging site by:
transmitting commands using an output module to perform automated actions at the indoor closed environment EV charging site, wherein the commands comprise:
performing automated vehicle check-in and assignment;
conducting vehicle flow control;
conducting adaptive charging management; and
conducting a post-charge vehicle transfer.
